(19) United States
(12) Patent Application Publication
(10) Pub. No.: US 2020/0408263 A1
(43) Pub. Date: Dec. 31, 2020

(54) FRICTIONAL PART

(71) Applicant: Schaeffler Technologies AG & Co. KG, Herzogenaurach (DE)

(72) Inventors: Marcel Adrian, Kehl (DE); Fabian Stope, Karlsruhe (DE); Markus Ciesek, Bühl (DE)

(73) Assignee: Schaeffler Technologies AG & Co. KG, Herzogenaurach (DE)

(21) Appl. No.: 16/767,252

(22) PCT Filed: Nov. 5, 2018
(86) PCT No.: PCT/DE2018/100893

§ 371 Date: May 27, 2020

(30) Foreign Application Priority Data
Nov. 30, 2017 (DE) 10 2017 128 403.6

(51) Int. Cl. F16D 13/64; F16D 13/72

(52) U.S. Cl. CPC F16D 13/648; F16D 69/00; F16D 13/72

(57) ABSTRACT

A friction part includes a friction surface with a first friction zone, a second friction zone, and a first circumferentially extending groove band separating the first friction zone from the second friction zone in a radial direction. At least one dimension of the first friction zone, the second friction zone, or the first circumferentially extending groove band is optimized with respect to a cooling behavior of the frictionally operating device. In an example embodiment, the friction surface has a third friction zone and a second circumferentially extending groove band separating the second friction zone from the third friction zone. The first friction zone is a radially innermost friction zone and a first radial dimension of the first friction zone is approximately 1 to 2 times a sum of a second radial dimension of the second friction zone and a third radial dimension of the third friction zone.

### CROSS-REFERENCE TO RELATED APPLICATIONS

This application is the United States National Phase of PCT Appln. No. PCT/DE2018/100893 filed Nov. 5, 2018, which claims priority to German Application No. DE102017128403.6 filed Nov. 30, 2017, the entire disclosures of which are incorporated by reference herein.

### TECHNICAL FIELD

The disclosure relates to a friction part, in particular for a wet-running, frictionally operating device, such as a wet-running friction clutch or friction brake, with at least one friction surface which has friction zones which are separated from one another in the radial direction by interposition of a groove band extending in the circumferential direction. The disclosure further relates to a wet-running multi-plate clutch or multiple-disc brake with at least one such friction part.

### BACKGROUND

A clutch disc is known from U.S. Pat. No. 4,995,500, which comprises several radially separated friction zones, between which several circumferentially extending grooves are arranged.

### SUMMARY

A friction part, in particular for a wet-running, frictionally operating device, such as a wet-running friction clutch or friction brake, includes at least one friction surface which has friction zones which are separated from one another in the radial direction by interposition of a groove band extending in the circumferential direction. At least one dimension of the friction zones and/or at least one groove band is optimized with regard to the cooling behavior of a frictionally operating device equipped with the friction part. The friction zones can also be referred to as friction power zones. A friction zone or a friction power zone corresponds to an area in which the friction part, which is preferably designed as a friction disc, has direct contact with a counter surface that is provided, for example, on a steel plate.

The friction design of the friction part, in particular of the friction disc, results in several friction zones separated from each other in the radial direction with preferred radial dimensions and positions, which has a positive influence on the cooling behavior of the frictionally operating device equipped with the friction part, e.g., a friction clutch or a multi-plate clutch. During operation of the frictionally operating device, for example the friction clutch or multi-plate clutch, the friction power is no longer continuously introduced radially during a slip phase, but within at least two self-contained friction power zones or friction zones which are separated from each other by an interposed groove band.

The friction design of the friction part, e.g., the friction disc, is designed in such a way that at least two friction zones or friction power zones are created which are separated from one another over the radius. Through local power input, the temperature profile of the friction part can be positively influenced in such a way as to maximize the driving temperature difference between the surface of the friction part, especially the disc surface, and a fluid used for cooling, whereby the energy absorption by the fluid is also maximized. The thermal conductivity of the fluid is better utilized if the peak temperature of the friction part, in particular a peak temperature of the disc, drops.

An exemplary embodiment of the friction part is characterized in that a radial dimension of a radially innermost friction zone of a total of three friction zones is approximately one to two times a sum of the radial dimensions of the two radially outer friction zones. The terms axial, radial and circumferential direction refer to an axis of rotation of the friction part. Axial means in the direction of or parallel to the axis of rotation. Radial means transverse to the axis of rotation. The three friction zones each have the shape of concentrically arranged circular ring surfaces. A first groove band is arranged between a first and a second friction zone. A second groove band is arranged between a second and a third friction zone.

A friction lining is arranged in the friction zone. The friction lining can be designed in one or more parts. The friction lining may include a large number of friction lining pieces, which are also referred to as pads. The friction lining pieces or pads may be spaced apart from one another, so that there are grooves in the friction zones which allow the passage of fluid. A border zone between two friction zones is referred to as a groove band. The groove band is bounded radially on the inside by an outer diameter of an inner friction zone and radially on the outside by an inner diameter of an outer friction zone. With the disclosed values, good results were achieved in tests and examinations carried out within the scope of the present disclosure.

Another exemplary embodiment of the friction part is characterized in that a radial dimension of a radially innermost friction zone of a total of four friction zones is approximately 0.5 to 1 times a sum of the radial dimensions of the three radially outer friction zones. The four friction zones have the shape of circular ring surfaces, which are arranged concentrically. A groove band is arranged between two friction zones. With the disclosed values, good results were achieved in tests and examinations carried out within the scope of the present disclosure.

Another exemplary embodiment of the friction part is characterized in that a radial dimension of a radially outermost friction zone is approximately 0.75 to 2 times the radial dimension of a radially outermost groove band. With the disclosed values, good results were achieved in tests and examinations carried out within the scope of the present invention.

Another exemplary embodiment of the friction part is characterized in that a radial dimension of a radially innermost friction zone of a total of two or three friction zones is approximately 0.5 to 3 times the radial dimension of a radially innermost groove band. With the disclosed values, good results were achieved in tests and examinations carried out within the scope of the present disclosure.

A further exemplary embodiment of the friction part is characterized in that a ratio of a sum of the radial dimensions of all friction zones to a total radial dimension of a contact area is approximately fifty to eighty percent. The radial contact area includes all friction zones and the groove bands arranged between the friction zones. With the disclosed values, good results were achieved in tests and examinations carried out within the scope of the present disclosure.

A further exemplary embodiment of the friction part is characterized in that a radially outermost groove band begins with a total of three and four friction zones in the radial direction at approximately between fifty to seventy-five percent of a or the overall radial dimension of a or the contact area. With the disclosed values, good results were achieved in tests and examinations carried out within the scope of the present disclosure.

A further exemplary embodiment of the friction part is characterized in that a radially outermost groove band begins with a total of two friction zones in the radial direction at approximately between forty to fifty percent of a or the radial overall dimension of a or the contact area. With the disclosed values, good results were achieved in tests and examinations carried out within the scope of the present disclosure.

Another exemplary embodiment of the friction part is characterized in that a radially innermost groove band begins in the radial direction at approximately between thirty to sixty percent of a or the overall radial dimension or the contact area. With the disclosed values, good results were achieved in tests and examinations carried out within the scope of the present disclosure.

The disclosure further relates to a wet-running multi-plate clutch or multi-plate brake with at least one previously described friction part. The friction part may be equipped on both sides with the friction zones and groove bands described above. The groove design in the friction zones can be carried out in a manner similar to that of conventional friction discs.

### BRIEF DESCRIPTION OF THE DRAWINGS

Further advantages, features and details of the disclosure emerge from the following description, in which various exemplary embodiments are described in detail with reference to the drawing. In the following:

FIG. 1 shows a friction part designed as a friction disc with a friction surface comprising two friction zones which are separated from each other by a groove band extending in the circumferential direction, according to a first exemplary embodiment in plan view;

FIG. 2 shows a Cartesian coordinate system showing friction performance histories in the friction zones of the friction part from FIG. 1 and a corresponding temperature profile over the radius of the friction part;

FIG. 3 shows a similar friction part as in FIG. 1 in plan view according to a second exemplary embodiment;

FIG. 4 shows a friction part with a friction surface according to a third exemplary embodiment with three friction zones and two groove bands in plan view;

FIG. 5 shows a Cartesian coordinate system, in which the friction performance histories and a temperature profile over a radius of the friction part from FIG. 4 are shown; and

FIG. 6 shows a bar chart in which dimensions of friction zones and groove bands of friction parts, as shown in FIGS. 1, 3 and 4, are optimized according to a total of twenty designs with regard to the cooling behavior of a frictionally operating device equipped with such a friction part.

### DETAILED DESCRIPTION

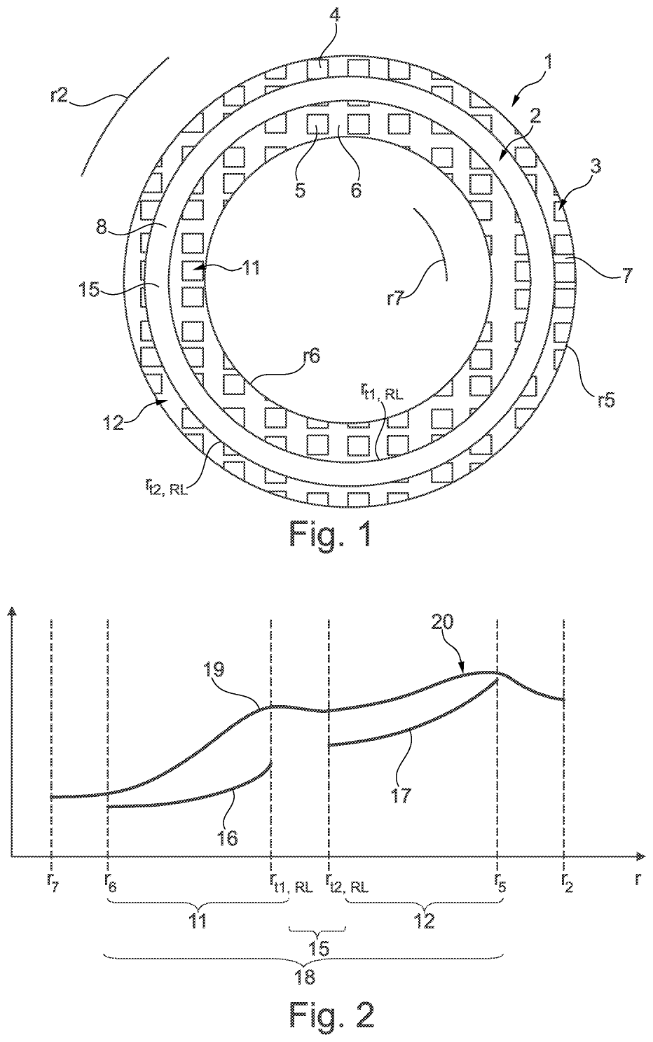

In FIGS. 1, 3 and 4, three exemplary embodiments of a friction part 1; 21; 41 with a support element 2; 22; 42 in a top view of a friction surface 3; 23; 43 are shown. The support element 2 is, for example, a support plate on which friction lining pieces 4, 5; 24, 25; 44 to 46 are bonded to represent the friction surface 3; 23; 43. The friction lining pieces 4, 5; 24, 25; 44 to 46 are arranged in a defined groove pattern and spaced apart from one another, so that fluid passage regions 6 to 8; 26 to 28; 47 to 50 result, which are also referred to as grooves.

In the friction part 1 shown in FIG. 1, the friction lining pieces 4, 5 have the shape of squares arranged in a waffle pattern so that the fluid passage areas 6 run in the vertical direction and the fluid passage areas 7 run in the horizontal direction in FIG. 1. The friction surface 3 comprises two friction zones 11, 12, which are separated from one another by the fluid passage area 8, which represents a groove band 15.

In FIGS. 1, 3 and 4, arcs r2 and r7 indicate an outer diameter and an inner diameter of a steel plate, not shown, with which friction surface 3; 23; 43 comes into contact during the operation of a multi-plate clutch equipped with friction part 1; 21; 41. The contact area between the steel plate and the friction part 1; 21; 41 is delimited radially on the inside by an inside diameter or inside radius r6. The contact area between the steel plate and the friction plate 1; 21; 41 is limited by an outer diameter or outer radius r5.

In the case of a design of conventional friction parts without groove bands, that is to say without interruptions in a friction power zone between the friction plate and the steel plate, the friction power zone or friction zone corresponds to the entire contact area. Tests and examinations carried out within the scope of the present disclosure have shown that the maximum temperature of the friction disc, which is also referred to as the peak temperature, can be undesirably high.

The heat exchange between the friction plate and a fluid used for cooling is generally described by the following equation:

Q=αA(T_{disc surface}−T_{fluid}).

Here, α is the heat coefficient, A is the area effective for heat exchange and the two temperatures are the temperature difference between the disc surface and the fluid. In order to maximize the heat exchange between the clutch and the fluid and thus keep the thermal load on the plates low, the product of the three terms must be maximized. Among other things, the disclosure provides a contribution as to how the last term, the temperature difference, can be maximized without increasing the local peak temperature of the disc.

For this purpose, the friction design of the plate is divided into at least two friction zones or friction power zones 11, 12; 31, 32; 51 to 53 separated from each other over the full three hundred and sixty degree circumference by a circumferential groove band 15; 35; 55, 56.

In the friction part 1 shown in FIG. 1, the first self-contained friction zone or friction power zone 11 extends from the diameter r6 to a first part diameter r_{t1,RL}. The second friction zone or friction power zone 12 extends from a second partial diameter r_{t2,RL} to the diameter r5. Between the partial diameters r_{t1,RL} and r_{t2,RL}, there is a groove over the entire circumference, called groove strip 15, through which fluid flows, so that there is no contact between the steel plate and the friction disc 1.

As a result, due to the smaller available friction surface 3, which is reduced by the groove band 15, a higher friction power density is generated in the friction power zones or friction zones 11, 12 compared to conventional friction parts. At the same time, the groove band 15 between the friction power zones or friction zones 11, 12 provides a region free of friction power, so that overall the temperature difference between the friction plate 1 and the fluid is increased without increasing the peak temperature.

This is due to the fact that the fluid in the cool state is generally fed to a friction space via the inner diameter r6 or r7 and then absorbs thermal energy on its way to the outer diameter r5 or r2 according to the equation described above. A friction space is designated as a ring space, which is delimited radially on the inside by an inner disc carrier and radially on the outside by an outer disc carrier. The friction parts or friction discs are arranged alternately with the steel plates in the friction chamber. If more power is transmitted locally in the radially innermost friction power zone 11, the temperature of the discs rises more and the difference to the fluid temperature increases.

In FIG. 2, a Cartesian coordinate system, on the x-axis of which the radius r is plotted in a suitable unit of length, shows an exemplary temperature profile of friction disc from FIG. 1, which is dependent on the respective load case, by means of line 19 and the now divided friction power curve by means of two lines 16, 17. It can be seen that there are two friction power zones 11, 12 corresponding to the circumferential groove band 15. The contact area 18 still defines the limits of the contact between the friction disc and the steel plate. At 20, the friction disc 1 has the maximum temperature or peak temperature.

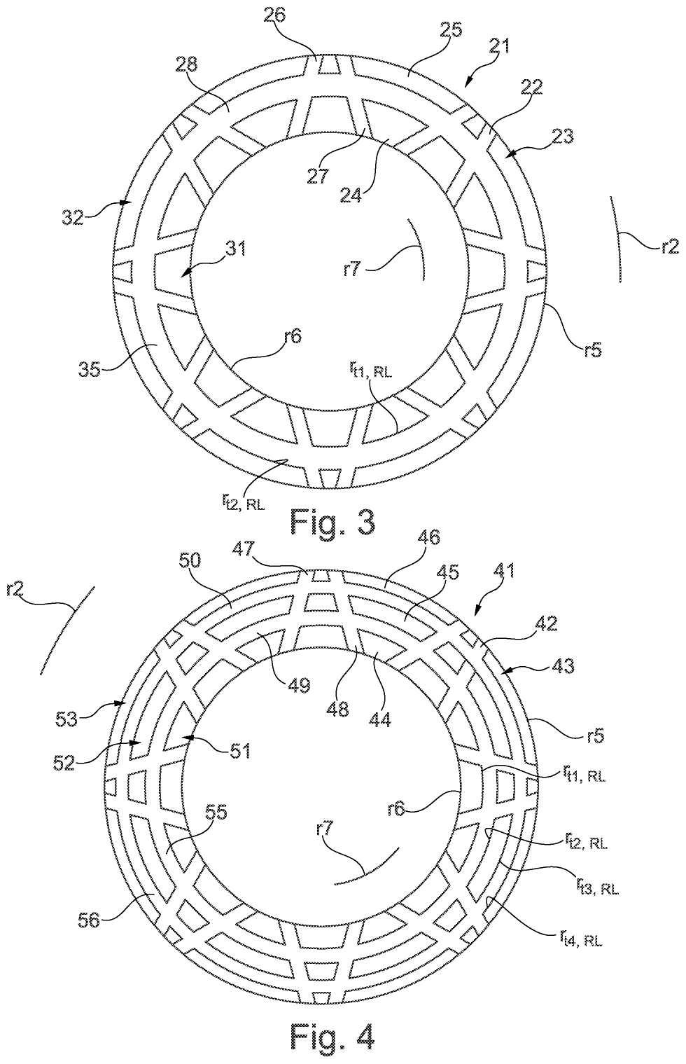

In the friction part 21 shown in FIG. 3, the friction lining pieces 24, 25 are designed differently than in the friction part 1 in FIG. 1. However, the central idea of the disclosure is independent of the friction lining design. Furthermore, the disclosure is not limited to two friction power zones 11, 12; 31, 32, but can also be divided into three or more power zones.

In order to maximize the thermal energy transferred from the clutch to the fluid and thus minimize the peak temperature of the disc, the tests and investigations carried out within the framework of the present disclosure have identified preferred conditions in which the friction zones and circumferential groove bands should be located in their radial dimension, also referred to as width, and in their positions relative to each other.

The friction part 41 shown in FIG. 4 is an example with three friction power zones or friction zones 51 to 53 with different dimensions in the radial direction or width. The innermost friction power zone extends from r6 to r_{t1,RL}, the middle one from r_{t2,RL} to r_{t3,RL}, and the outermost one from r_{t4,RL} to r5. The areas in between are designed as circumferential grooves, which are referred to as groove bands 55, 56 and represent flow areas for the fluid.

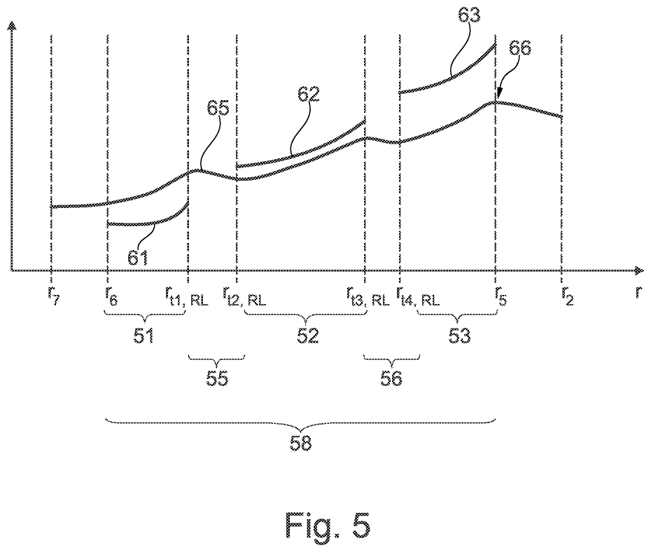

FIG. 5 shows schematically in the same way as in FIG. 2 the temperature curve over the friction part 41 from FIG. 4 with the three friction power zones or friction zones 51 to 53 and the two circumferential groove bands 55, 56. Lines 61 to 63 represent the tripartite friction power curve. Line 65 shows the associated temperature profile of the friction disc 41. With 66, the peak temperature of the friction disc 41 is designated.

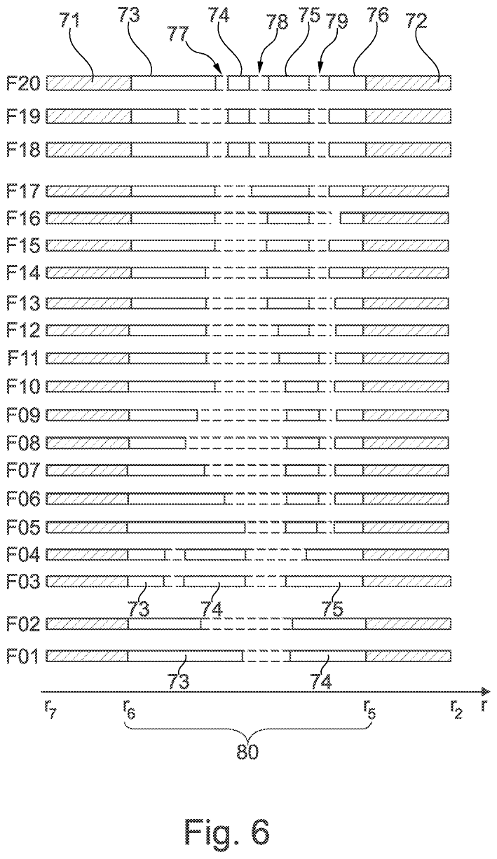

FIG. 6 shows a selection of cross-sectional profiles F01 to F20 of the friction disc according to the disclosure, which show preferred configurations within the meaning of the disclosure. The profiles F01 to F20 were designed in the course of the tests and examinations carried out within the scope of the disclosure on the basis of technically customary driving situations and, compared to conventional friction discs, have a lower peak temperature of the disc and, consequently, a lower thermal load.

The cross-sectional profiles in FIG. 6 are normalized to an identical length. The contact area 80 of the friction disc and clutch disc or steel plate extends between the radii r6 and r5. Hatched bars 71 and 72 indicate areas without contact between the friction disc and the steel plate. Bars 73 to 76 indicate friction zones which are separated from one another by groove bands 77 to 79.

The profiles F01 and F02 show two possible configurations with two separate friction zones 73, 74. The profiles F3 to F17 show configurations with three separate friction zones 73 to 75. The profiles F18 to F20 show configurations with four radially separate friction zones 73 to 76.

In the tests and investigations carried out within the scope of the present disclosure, the following relationships have proven to be advantageous in the sense of a lower peak temperature of discs compared to conventional friction discs:

With three friction zones, the radial length of the radially innermost friction zone should be about one to two times the sum of the two radially outer friction zones. With four friction zones, the radial length of the radially innermost friction zone should be approximately 0.5 to 1 times the sum of the three radially outer friction zones.

The radial length of the radially outermost friction zone should be approximately 0.75 to 2 times the radial length of the radially outermost groove band. In the case of two or three friction zones, the radial length of the radially innermost friction zone should be approximately 0.5 to 3 times the radial length of the radially innermost groove band.

The ratio of the sum of the radial length of all friction zones to the total radial contact area length should be approximately fifty to eighty percent. With three and four friction zones, the radially outermost groove band should begin radially between approximately fifty to seventy-five percent of the total radial contact area length.

With two friction zones, the radially outermost groove band should begin radially between approximately forty to fifty percent of the total radial contact area length. The radially innermost groove band should begin radially between about thirty to sixty percent of the total radial contact area length.

### REFERENCE NUMERALS

1 Friction Part
2 Support Element
3 Friction Surface
4 Friction Lining Piece
5 Friction Lining Piece
6 Fluid Passage Area
7 Fluid Passage Area
8 Fluid Passage Area
11 Friction Zone
12 Friction Zone
15 Groove Band
16 Line
17 Line
18 Contact Area
19 Line
20 Peak Temperature
21 Friction Part
22 Support Element
23 Friction Surface
24 Friction Lining Piece
25 Friction Lining Piece
26 Fluid Passage Area
27 Fluid Passage Area
28 Fluid Passage Area
31 Friction Zone
32 Friction Zone
35 Groove Band
41 Friction Part
42 Support Element
43 Friction Surface
44 Friction Lining Piece
45 Friction Lining Piece
46 Friction Lining Piece
47 Fluid Passage Area
48 Fluid Passage Area
49 Fluid Passage Area
50 Fluid Passage Area
51 Friction Zone
52 Friction Zone
53 Friction Zone
55 Groove Band
56 Groove Band
58 Contact Area
61 Line
62 Line
63 Line
65 Line
66 Peak Temperature
71 Hatched Bars
72 Hatched Bars
73 Friction Zone
74 Friction Zone
75 Friction Zone
76 Friction Zone
77 Groove Band
78 Groove Band
79 Groove Band
80 Radial Contact Area

1.-10. (canceled)

11. A friction part for a wet-running, frictionally operating device comprising:
a friction surface comprising:
a first friction zone;
a second friction zone; and
a first circumferentially extending groove band separating the first friction zone from the second friction zone in a radial direction, wherein
at least one dimension of the first friction zone, the second friction zone, or the first circumferentially extending groove band is optimized with respect to a cooling behavior of the frictionally operating device.

12. The friction part of claim 11, wherein:
the friction surface comprises a third friction zone and a second circumferentially extending groove band separating the second friction zone from the third friction zone;
the first friction zone is a radially innermost friction zone; and
a first radial dimension of the first friction zone is approximately 1 to 2 times a sum of a second radial dimension of the second friction zone and a third radial dimension of the third friction zone.

13. The friction part of claim 11, wherein:
the friction surface comprises:
a third friction zone and a second circumferentially extending groove band separating the second friction zone from the third friction zone; and
a fourth friction zone and a third circumferentially extending groove band separating the third friction zone from the fourth friction zone;
the first friction zone is a radially innermost friction zone; and
a first radial dimension of the first friction zone is approximately 0.5 to 1 times a sum of a second radial dimension of the second friction zone, a third radial dimension of the third friction zone, and a fourth radial dimension of the fourth friction zone.

14. The friction part of claim 11, wherein:
the first friction zone is a radially outermost friction zone; and
a first radial direction of the first friction zone is approximately 0.75 to 2 times a second radial dimension of the first circumferentially extending groove band.

15. The friction part of claim 11, wherein:
the first friction zone is a radially innermost friction zone; and
a first radial dimension of the first friction zone is approximately 0.5 to 3 times a radial dimension of the first circumferentially extending groove band.

16. The friction part of claim 15 wherein the friction surface comprises a third friction zone and a second circumferentially extending groove band separating the second friction zone from the third friction zone.

17. The friction part of claim 11, wherein:
the friction surface comprises a contact area bounded by an inner diameter of the first friction zone and an outer diameter of the second friction zone; and
a ratio of a sum of a first radial dimension of the first friction zone and a second radial dimension of the second friction zone to a third radial dimension of the contact area is approximately fifty to eighty percent.

18. The friction part of claim 11 wherein:
the friction surface comprises:
a third friction zone;
a second circumferentially extending groove band separating the second friction zone from the third friction zone; and
a contact area bounded by an inner diameter of the first friction zone and an outer diameter of the third friction zone; and
a ratio of a sum of a first radial dimension of the first friction zone, a second radial dimension of the second friction zone, and a third radial dimension of the third friction zone to a fourth radial dimension of the contact area is approximately fifty to eighty percent.

19. The friction part of claim 11 wherein:
the friction surface comprises:
a third friction zone;
a second circumferentially extending groove band separating the second friction zone from the third friction zone;
a fourth friction zone;
a third circumferentially extending groove band separating the third friction zone from the fourth friction zone; and
a contact area bounded by an inner diameter of the first friction zone and an outer diameter of the fourth friction zone; and
a ratio of a sum of a first radial dimension of the first friction zone, a second radial dimension of the second friction zone, a third radial dimension of the third friction zone, and a fourth radial dimension of the fourth friction zone to a fifth radial dimension of the contact area is approximately fifty to eighty percent.

20. The friction part of claim 11, wherein:
the friction surface comprises:
a third friction zone and a second circumferentially extending groove band separating the second friction zone from the third friction zone;
a fourth friction zone and a third circumferentially extending groove band separating the third friction zone from the fourth friction zone; and
a contact area bounded by a first inner diameter of the first friction zone and an outer diameter of the fourth friction zone;
the first friction zone is a radially innermost friction zone; and
a second inner diameter of the third circumferentially extending groove band is approximately fifty to seventy-five percent of a radial dimension of the contact area.

21. The friction part of claim 11, wherein:
the friction surface comprises a contact area bounded by a first inner diameter of the first friction zone and an outer diameter of the second friction zone; and
a second inner diameter of the first circumferentially extending groove band is approximately forty to fifty percent of a radial dimension of the contact area.

22. The friction part of claim 11, wherein:
the friction surface comprises a contact area bounded by a first inner diameter of the first friction zone and an outer diameter of the second friction zone; and
a second inner diameter of the first circumferentially extending groove band is approximately thirty to sixty percent of a radial dimension of the contact area.

23. A wet-running multi-plate clutch or multiple-disc brake comprising the friction part of claim 11.
